(19) United States
(12) Patent Application Publication
(10) Pub. No.: US 2009/0209667 A1
(43) Pub. Date: Aug. 20, 2009

(54) Recycled Poly(vinyl butyral)

(76) Inventors: Helen Mackin Thompson, Somers, CT (US); Berkeley Anton Jemmott, Springfield, MA (US)

Correspondence Address: BRENC LAW;ANDREW BRENC, P.O. BOX 155, ALBION, PA, 16401-0155, US

(21) Appl. No.: 12/032,635

(22) Filed: Feb. 15, 2008

(51) Int. Cl. C08J 11/08; C08F 110/02

(52) U.S. Cl. 521/47; 526/315

(57) ABSTRACT

The present invention provides a method of recycling poly(vinyl butyral) resin and incorporating that poly(vinyl butyral) resin into laminated glass and other articles. Poly(vinyl butyral) resin is recovered from discarded laminated glass through a well defined process, as described herein as the present invention, that includes all or most of the steps of granulation of the laminated glass, solvent extraction of plasticizer and impurities, dissolution of poly(vinyl butyral), pre-filtration of insoluble contaminants, color removal via adsorption or bleaching, post-filtration of carbon particles, precipitation of poly(vinyl butyral), and washing, stabilization, and drying of poly(vinyl butyral) resin.

### FIELD OF THE INVENTION

The present invention is in the field of poly(vinyl butyral) resin manufacture, and, specifically, the present invention is in the field of the recovery and reuse of poly(vinyl butyral) resin that has served its primary function.

### BACKGROUND

Automobile windshields and architectural safety glass are typically composed of two sheets of glass laminated together with an interposed, plasticized polymer layer. Poly(vinyl butyral) is the polymer that is the main component in the polymeric interlayer of the vast majority of automotive windshields and architectural safety glass.

Poly(vinyl butyral) resin is typically manufactured through a synthesis process that begins with the separation of ethane directly from natural gas or from the petroleum refining process. Ethane is then steam cracked to produce ethene (ethylene), which, along with acetic acid feedstock, is used to produce vinyl acetate monomers. Vinyl acetate monomers, through free-radical polymerization, are polymerized to poly(vinyl acetate). Poly(vinyl acetate) is hydrolyzed to poly(vinyl alcohol), which is then reacted with butyraldehyde to form poly(vinyl butyral).

The above-described synthesis process is energy intensive and dependent upon the use of non-renewable feedstocks. Consequently, the prospect of recycling poly(vinyl butyral) resin from laminated glass that has served its primary function and is being discarded as scrap has been long considered in the art as a potentially valuable source of poly(vinyl butyral) that would be less costly to produce than virgin poly(vinyl butyral) resin and that could significantly reduce the environmental footprint of poly(vinyl butyral) production.

To date, despite the long felt need in the art, there are no commercial scale, post-consumer poly(vinyl butyral) recycling plants in operation. The lack of such plants is due in substantial part to the practical processing difficulties that are encountered when poly(vinyl butyral) interlayer is removed from glass. Poly(vinyl butyral) interlayer, by design, adheres very strongly to glass. While that adhesion is very desirable when the poly(vinyl butyral) interlayer is preventing loose glass shards from becoming detached and potentially dangerous after an object impacts a laminated glass panel, it makes separation of glass and polymer for the purpose of recycling very difficult. This difficulty is largely responsible for the current absence of any large scale, post-consumer poly(vinyl butyral) resin recycling facility.

What are needed in the art are effective, inexpensive, and environmentally efficacious methods of recycling poly(vinyl butyral) that result in high quality poly(vinyl butyral) resin that can be used in place of or in combination with virgin poly(vinyl butyral) resin.

### SUMMARY OF THE INVENTION

The present invention provides a method of recycling poly(vinyl butyral) resin and incorporating that poly(vinyl butyral) resin into laminated glass and other articles. Poly(vinyl butyral) resin is recovered from discarded laminated glass through a well defined process, as described herein as the present invention, that includes all or most of the steps of granulation of the laminated glass, solvent extraction of plasticizer and impurities, dissolution of poly(vinyl butyral), pre-filtration of insoluble contaminants, color removal via adsorption or bleaching, post-filtration of adsorbent particles, precipitation of poly(vinyl butyral), and washing, stabilization, and drying of poly(vinyl butyral) resin.

### DETAILED DESCRIPTION

Recycling of poly(vinyl butyral) resin according to the methods of the present invention begins with the acquisition of laminated glass panels that are no longer useful for their original purpose or are otherwise designated as scrap. Scrap poly(vinyl butyral) is available, for example, from vehicles that have reached the end of their service life, from broken windshields on in-service vehicles that are replaced, or from seconds or otherwise unusable newly manufactured laminated panels from lamination facilities.

Scrap poly(vinyl butyral) interlayer can typically be obtained in the form of “flappers”, which are sections of poly(vinyl butyral) sheet that have been produced by a mechanical shredder. Mechanical shredders will, typically, shred windshields and other laminated glass panels into a mixture of glass, poly(vinyl butyral) interlayer, metal, and other materials. Metal detection and mechanical sifting can then be used to separate the larger pieces of poly(vinyl butyral) interlayer from the other components of the flappers. Complete separation is not possible, of course, and the recovered poly(vinyl butyral) interlayer will be adhered to glass, rubber, and other contaminants.

Whether poly(vinyl butyral) is obtained in the form of flappers or in the form of interlayers imbedded in complete laminated glass panels, the poly(vinyl butyral) and glass are first granulated to prepare the poly(vinyl butyral) for further processing.

### Granulation Step

The first step in the recycling process of the present invention is the granulation of the scrap mixture (flappers) from laminated glass panels. Granulation can be performed using any suitable device, which can be, for example, a commercial granulator such as a Granutec granulator (East Douglas, Mass., USA). In preferred embodiments, the scrap mixture is obtained by passing the scrap laminated panels through a mechanical glass shredder. The scrap mixture may contain several components used in the laminated glass panel. The flappers are then granulated to reduce their size.

Granulation of flappers can result in individual granulated flakes that have a long dimension of less than 2.6 centimeters, or 0.1 to 1.0 centimeters, or 0.4 to 0.8 centimeters. While granulated flakes above 2.6 centimeters in size can be used, it is generally desirable to granulate the flappers to a smaller size, which results in a greater total granulated flake surface area.

At any point during granulation, the granulated flakes can be sifted to remove the glass fragments, glass dust, and other contaminants that have been freed from the poly(vinyl butyral).

### Extraction Step

While many previous attempts to recycle poly(vinyl butyral) have attempted to process the plasticizer and the polymer components together, the present invention eliminates the difficulties experienced with that conventional approach by separating the two components through solvent extraction of the plasticizer and subsequent purification of a resin stream and, optionally, a plasticizer stream.

After granulation, plasticizer and other non-poly(vinyl butyral) components, such as inks, dyes, ultraviolet stabilizers, and additives, are extracted from the granules using a suitable extraction solvent. Any solvent can be used that can selectively extract the plasticizer without also removing unacceptably large amounts of poly(vinyl butyral). Preferably, the chosen extraction solvent will extract all common plasticizers and other additives, including triethylene glycol di-2,ethylbutyrate (3 GH), triethylene glycol di-2-ethylhexanoate (3GEH), triethylene glycol di-heptanoate (3G7), tetraethylene glycol di-heptanoate (4G7), tetraethylene glycol di-2,ethylhexanoate (4GEH), di-hexyl adipate (2HA), di-octyl adipate (DOA), butyl benzyl phthalate (BBP), di-iso octyl phthalate (DIOP), butyl sebacate, phosphate esters, ricinoleates, and ultraviolet stabilizers, including 2-(2-hydroxy-5-methylphenyl) benzotriazole (Tinuvin®-P), 2-(2′-hydroxy-3′-tert-butyl-5-methylphenyl)-5-chloro benzotriazole (Tinuvin® 326), 2-(2′-hydroxy-3′,5′-ditert-butylphenyl)-benzotriazole (Tinuvin®-328).

Suitable extracting solvents include acetone, hexane, methyl acetate, ethyl acetate, toluene, heptane, or any combination thereof, with a two or three component combination preferred.

In various embodiments, the solvent used is a 75/25 volume/volume mixture of hexane/ethyl acetate.

Extraction can be accomplished in any suitable manner, including, but not limited to, in a batch style in which granulated flappers are agitated in the solvent in a batch mode, or in an immersion style system in which granulated flappers are moved through a replenishing solvent bath.

In one embodiment, a continuous counter current extractor is used, such as a Model IV Immersion Style Extractor (Crown Iron Works Company, Minneapolis, Minn., U.S.). Other examples of suitable extractor devices include: horizontal-basket design, endless belt percolator, Kennedy extractor, vertical-plate extractors, such as a Bonotto extractor, and screw-conveyer extractor (see, for example, Perry's Chemical Engineers' Handbook, Edited by: Perry, R. H.; Green, D. W., McGraw-Hill, 7^{th} ed, pp 18-55).

After extraction, the solvent, with plasticizer, is separated from the poly(vinyl butyral) granules, which can be dried in a flash dryer or otherwise dried to remove the remaining solvent. The solvent and plasticizer can be separately processed in a solvent and/or plasticizer recovery unit.

Poly(vinyl butyral) Dissolution Step

Poly(vinyl butyral) granules from the extraction step, along with associated glass and other contaminants, are next subjected to a dissolution step in which poly(vinyl butyral) is separated from most of the remaining glass by dissolving the poly(vinyl butyral) in a suitable solvent.

Suitable solvents for the dissolution step include methanol, ethanol, n-propanol, isopropanol, n-butanol, methyl acetate, cyclohexanone, and diacetone alcohol.

In various embodiments, ethanol is used as the solvent in the dissolution step.

As with the extraction step, the dissolution step can be carried out using any suitable method, and, in various embodiments, the dissolution step is carried out using a batch method or a continuous process.

In various embodiments of the present invention, the total solids to solvent weight ratio can be 20:80 to 5:95, or 15:85 to 10:90.

The rate of dissolution of poly(vinyl butyral) can be increased by increasing the temperature of the solvent mixture. In a preferred embodiment, the solvent is heated to just below the reflux temperature during the dissolution step.

In another embodiment of the present invention, the inventive method is used to separate two poly(vinyl butyral) resins from a single batch of granules. This embodiment is particularly useful for recycling interlayers that have multiple layers, such as are found in many acoustic interlayers. For this embodiment, a solvent is chosen for the dissolution step that selectively dissolves a first poly(vinyl butyral) resin and not a second poly(vinyl butyral) resin. As will be recognized by those of skill in the art, the selective solvent will be chosen based on the compositional differences of the resins, in combination with the intended processing temperature of the solvent. For example, differences in molecular weight, residual hydroxyl (poly(vinyl alcohol)) content, and/or residual acetate (poly(vinyl acetate)) content all affect solubility of a poly(vinyl butyral) resin, and a solvent can be chosen based on those differences. Further, a resin's solubility in a particular solvent will depend on the temperature of the solvent, and that dependency can be used to choose an appropriate solvent for a given resin.

The above, selective dissolution can be extended as needed. In a two resin mixture, a first solution can be used to dissolve and remove a first resin, and, if recovery of the second resin is desired, a second solution can be used to dissolve the second resin. If the mixture has more than two resins, then additional solutions can be used, as needed.

In one embodiment, a series of solutions are used to selectively dissolve separate resin fractions from a mixture of interlayers that comprises multiple resins.

In any of the above embodiments, continued processing of one or more of the dissolved resins in the multiple solvents proceeds for each solvent as described below for single poly(vinyl butyral) solvent embodiments, as desired.

In various embodiments the residual poly(vinyl alcohol)(PVOH) content is 8% to 25%, the residual poly(vinyl acetate)(PVAC) content is 0.01% to 15%, and the molecular weight is 20,000 to 400,000.

In one embodiment, a high molecular weight and/or low residual poly(vinyl alcohol) polymers is selectively precipitated and separated from a lower molecular weight and/or high residual poly(vinyl alcohol) content by increasing the water content in a water/solvent mixture. Any suitable solvent, such as methanol, ethanol, n-propanol, iso-propanol, n-butanol, methyl acetate, cyclohexanone, or diacetone alcohol can be used for this purpose.

### Filtration Steps

The result of dissolution is a poly(vinyl butyral) solution comprising poly(vinyl butyral) dissolved in the solvent as well as suspended contaminants, such as complex dyes, pigments, and some residual glass.

The poly(vinyl butyral) solution from the dissolution step may optionally be filtered to separate the impurities from poly(vinyl butyral) solution. Of course, the type and extent of filtration will depend on the intended end use for the poly(vinyl butyral) resin. For example, the intended use of the poly(vinyl butyral) resin derived from the process of the present invention may be in applications where resin coloration is not undesirable, or where minor particulate contamination is acceptable in the end product. Examples of such applications include architectural applications and automotive applications in which a heavily tinted glass laminate or a glass laminate having intentionally added particulate matter in the laminate is used. Other examples are non-optical applications, such as carpet backing, adhesives, and PVC floor tiles.

Separation of most of the impurities, such as glass, dirt, non-poly(vinyl butyral) polymers, and pigments can be accomplished by a mechanical solid liquid separation method, such as filtration or centrifugation. For some embodiments, the poly(vinyl butyral) solution is mechanically filtered through a filter having the desired pore size, such as 0.1 to 10 microns, 0.1 to 5 microns, 1 to 4 microns, or 2 to 3 microns. Due to the high viscosity of the solution, as the pore size is reduced the filtration areas should be increased to maintain the filtration rate. An example of such a filtration device is the Pall VELAdisc Series by ENPRO Inc. (Addison, Ill.) with a filtration area of 1.8 meters squared.

Remaining impurities, such as dyes, can be separated subsequently using a method that is suitable for filtering the relatively small dye molecule size or that advantageously uses the solubility characteristics of the dye molecules. One example is by adsorption of the impurities using an adsorbent material such as activated carbon, silicates, alumina silicates, alumina, or combinations of the foregoing.

Adsorption can be performed using any suitable batch or continuous device and process, including, for example, by passing the solution through activated carbon columns or by dispersing an activated carbon into the solution, agitating the solution for a sufficient amount of time, and then mechanically filtering out the activated carbon.

In various embodiments, activated carbon, for example Granular CAL activated carbon (Calgon Carbon Corporation), is added to the solution in the weight ratio range of (0.01 grams carbon):(1.0 grams poly(vinyl butyral) resin) to (1.0 grams carbon):(1.0 gram poly(vinyl butyral) resin). The solution is agitated for a suitable amount of time, which can be, for example, at least four hours. The temperature of the solution can be, for example, 30-70° C. The solution can then be mechanically filtered with a liquid-solid separation method similar to the one mentioned above with a retention size of 1 micron or, in various embodiments, with a retention size of less than 1 micron, as appropriate, to remove the carbon particles from the solution. The amount and type of Carbon and the contact time depends on the amount and type of colored impurities present in the solution.

### Precipitation Step

After dissolution and optional filtration, the poly(vinyl butyral) resin is isolated from the solution via a precipitation step. Precipitation can be accomplished in any suitable manner. In various embodiments, the poly(vinyl butyral) in ethanol solution is subjected to high shear agitation in a blender, in-line mixer, or disintegrator as water is slowly added as water is slowly added, and, as the concentration of water increases, the poly(vinyl butyral) resin precipitates out of solution in the form of a slurry. The precipitated resin slurry is transferred to another vessel and can then be washed, as needed, to remove the residual solvent, and then dried.

Washing of the precipitated resin can be done in any suitable manner and to the extent required for the intended end use of the resin. For example, washing can be done using an agitated stir tank that enables suspension of resin particle and that is fitted with screen barrels to enable continuous washing with water and removal of spent liquor with minimal loss of resin particles.

After washing, the resin can be dried, as needed. Drying can be done, for example, with a fluidized bed drier or in an oven. In various embodiments, the poly(vinyl butyral) resin is dried to less than 5%, less than 4%, or less than 2% volatile content. Drying, in additional to converting the resin into a dry form, functions to remove moisture and organic volatile components that can cause haze and bubbles in plasticized polymer layers made from the resin. After drying, the dried resin is ready for use.

At any point in the washing step, stabilizing compounds such as organic acids or organic acid salts can be added to enhance the thermal stability of the resin.

In one embodiment, for example, the poly(vinyl butyral) slurry is adjusted to a pH of between 6.5 and 7.5, or 6.8 and 7.2 after washing. The slurry is then heated to 55° C., and can then be kept in the designated pH range for about 45 minutes, at which point final adjustments to achieve the desired resin alkalinity (titer) can be made with the addition of potassium acetate or an equivalent organic acid salt. The slurry is then kept at an elevated temperature (55° C.) for another 30 minutes. The resin slurry is then cooled to room temperature. Filtering and drying complete the resin isolation process.

While the forgoing detailed description provides one method of isolating poly(vinyl butyral) resin from an ethanol solution via precipitation, washing, stabilization and drying, those of skill in the art will recognize that there will be many variations on the basic precipitation technique that could be effectively used to precipitate the poly(vinyl butyral) out of solution and that are within the scope of the present invention.

As used herein, “titer” can be determined for sodium acetate and potassium acetate (as used herein, the “total alkaline titer”) in a resin using the following method:

Approximately 5 g of resin is dissolved in ethanol or methanol or other suitable solvent and titrated to the acid/base endpoint using a standard titration mode with 0.005N alcoholic HCl, preferably via an automatic titroprocessor. A blank solvent (no sample) is also titrated to eliminate noise due to contaminants that may be present in the solvent Total alkaline titer is calculated as follows:

$$Total Alkaline Titer [ mls 0.01 N HCl \text{/} 100 g resin ] = \frac{50 \times ( \begin{matrix}0.005 N mls of HCl for sample - \\ 0.005 N mls of HCl for blank\end{matrix} )}{grams of resin}$$

The present invention includes an article of manufacture made from a recycled poly(vinyl butyral) resin of the present invention.

The present invention includes mixtures of recycled poly(vinyl butyral) resin of the present invention and virgin poly(vinyl butyral) resin.

Mixtures of the present invention can include any suitable amount of recycled poly(vinyl butyral) resin, and, in various embodiments, mixtures have 1 to 95, 1 to 75, 1 to 50, 1 to 25, or 1 to 10 weight percent of a recycled poly(vinyl butyral) resin of the present invention.

The clarity of a polymer sheet can be determined by measuring the haze value, which is a quantification of the scattered light by a sample in contrast to the incident light. The percent haze can be measured according to the following technique. An apparatus for measuring the amount of haze, a Hazemeter, Model D25, which is available from Hunter Associates (Reston, Va.), can be used in accordance with ASTM D1003-61 (Re-approved 1977)-Procedure A, using Illuminant C, at an observer angle of 2 degrees. In various embodiments of the present invention, percent haze is less than 5%, less than 3%, and less than 1%.

The “yellowness index” of a polymer sheet can be measured according to the following: transparent molded disks of polymer sheet 1 cm thick, having smooth polymeric surfaces which are essentially plane and parallel, are formed. The index is measured according to ASTM method D 1925, “Standard Test Method for Yellowness Index of Plastics” from spectrophotometric light transmittance in the visible spectrum. Values are corrected to 1 cm thickness using measured specimen thickness. In various embodiments of the present invention, a polymer sheet can have a yellowness index of 15 or less, 10 or less, or 8 or less.

In various embodiments of the present invention, an interlayer comprising a recycled poly(vinyl butyral) of the present invention has a haze value of less than 5 and a yellowness index of less than 14. In other embodiments, an interlayer comprising a recycled poly(vinyl butyral) of the present invention has a haze value of less than 4 and a yellowness index of less than 12.

Color values for a polymer sheet or resin pellets can be determined using ASTM D6290-05. The optical measurements of solution samples are measured using an optical (glass) cell of dimensions 50 millimeters×50 millimeters×20 millimeters cell path length and using a BYK Gardner Spectrophotometer (Geretsried, Germany). Prior to measurement of solution samples the instrument is standardized using the solvent as a “blank” sample.

### EXAMPLE 1

A 75/25 (by volume) mixture of hexane and ethyl acetate is added to a 2 liter jacketed and agitated vessel, and then flappers are obtained from a glass recycling facility, from which non-glass contaminants such as rubber are manually removed. The flappers are then granulated to about 0.1 to 1.0 centimeter flakes using a granulator and are gradually added to the vessel. Agitator speed is set at 800 rpm.

The amount of glass in the granulated flappers is estimated to be 30-35%. This is confirmed by a percent total solids (% TS) measurement after the completion of the dissolution step, below. The flappers contain clear and colored poly(vinyl butyral).

The initial weight of the flappers, including glass, added to the vessel is 24-25% of the solution (220 grams of flappers with glass and 672 grams of initial solvent). The extraction temperature is 40° C. and the extraction time is 4 hours. Samples of the liquor are taken every 30 minutes for analysis.

Analysis of the liquor samples via GC MS show that the liquor contained hexane, ethyl acetate, triethylene glycol di-(2-ethylhexanoate), triethylene glycol di-(2-ethylbutyrate), dihexyl adipate, tetraethylene glycol di-heptanoate, di-isooctyl phthalate, and Tinuvin® 326. The triethylene glycol di-(2-ethylhexanoate) plasticizer is found to account for the major portion of the plasticizers.

This batch operation results in the final extraction of 78% of the plasticizer from the poly(vinyl butyral) interlayer.

### EXAMPLE 2

The procedure in Example 1 is repeated, but, in order to increase the amount of extracted plasticizer, at each sampling 400 milliliters of the extraction solvent containing plasticizer are removed and replaced by 400 milliliters of fresh solvent. The extraction efficiency is increased to about 95%, most of which is extracted (about 82%) within the first 30 minutes of the 4 hours cycle.

### EXAMPLE 3

The extracted flappers from Example 2 are dried at 60° C. in an oven to remove the residual solvent. The final weight of the flappers after extraction and drying is about 177 grams, including glass. The amount of extracted plasticizer is estimated from the difference in the weight of the flappers before and after extraction. This weight difference is observed to be 43 grams.

The glass and contaminant content in the initial flappers affect the above calculation and is taken into account by measuring the percentage of polymer solid (% TS) in the polymer/ethanol solution obtained in the next step using an HR73 Halogen Moisture Analyzer (Mettler-Toledo, Columbus, Ohio, USA). Using the measured % TS and the initial weight of flappers, the amount of non-poly(vinyl butyral) components in the initial flappers is estimated and used in the calculation of the % extracted plasticizer in the extraction step.

### EXAMPLE 4

150 grams of solid flappers, as in Example 1, are weighed and placed inside the main chamber of a Soxhlet extractor. The Soxhlet extractor is placed onto a flask containing 600 milliliters of a 75/25 mixture, by volume, of hexane/ethyl acetate. The Soxhlet extractor is then equipped with a condenser.

The solvent is heated to reflux. The solvent vapor travels up a distillation arm and floods into the chamber housing the flappers. The condenser ensures that any solvent vapor cools and drips back down into the chamber housing the flappers.

The chamber containing the solid material slowly fills with warm solvent. The plasticizer in the flappers dissolves into the warm solvent.

When the Soxhlet chamber is almost full, the chamber is automatically emptied by a siphon side arm, with the solvent running back down to the distillation flask carrying some of the extracted plasticizer. This cycle is allowed to repeat many times. The cycle time is controlled by controlling the rate of heating of the solvent.

Extraction experiments are run for twelve 15 minute cycles, for a total of 3 hours. During each cycle, a portion of the plasticizer is dissolved in the solvent. After many cycles the desired compound is concentrated in the distillation flask.

It is found that the final amount of extracted plasticizer is comparable with the agitated vessel method of Example 2 (95%).

### EXAMPLE 5

1000 grams of Ethanol is added to a 2 liter vessel. The 177 grams of extracted granules (including glass) from Example 3 are then gradually added with the agitation speed at 800 rpm. The mixture is brought to 60° C. and held until the polymer is completely dissolved. Solution solids (% TS) via analysis upon cooling is observed to be about 10%. The poly(vinyl butyral) is completely dissolved in the ethanol in about 90 minutes at 60° C.

The resulting varnish solution is hazy due to the contaminant particles and pigments suspended in the solution, and it has a green/blue color originating from the colored poly(vinyl butyral) in the starting scrap material.

### EXAMPLE 6

The vanish solution from Example 5 is filtered using an Ertel Alsop 10T laboratory filter press unit (Ertel Alsop Company, Kingston, N.Y., USA) with 206.8 kPascals (30 pounds per square inch) air pressure and cellulose filter media. A clear solution is obtained when a 2.5 micron nominal retention size is used. The filtered solution is clear and free of dispersed particles after filtration with 2.5 micron pads, but it still shows a blue/green appearance.

### EXAMPLE 7

The filtration performed in Example 6 is repeated, but with a thermal blanket installed to heat the exterior walls of the unit. The solution is preheated to 60° C. and the exterior temperature is set to 67.8° C. (154° F.) to lower the viscosity. A significant improvement in filtration flow rate (faster) is observed but not quantified. The filtered varnish solution is subjected to optical testing and is shown to be of L=94.88, [a*]−3.38, [b*]=−0.96, % Haze=2.3, [YI]=−4.61 and % Tv=87.34.

### EXAMPLE 8

The colored varnish solution from Example 5 is brought in contact with Granular CAL (Calgon Carbon Corporation, Pittsburgh, Pa.) activated carbon in a 2 liter agitated vessel at 70° C. A weight ratio of 0.5 is used for carbon/poly(vinyl butyral) resin. Carbon treatment is run for 18 hours before cooling and filtering at 60° C. via the Ertel Alsop 10T laboratory filter press unit (Kingston, N.Y.) with 2.5 micron filtration.

Significant improvements in optical values over Example 7 are observed with L=97.67, [a*]=−1.78, [b*]=1.22, % Haze=1.54, [YI]=0.97 and % Tv=93.93

### EXAMPLE 9

Example 8 is repeated using the varnish solution from Example 7 with the carbon contact duration reduced to 4 hours at 70° C. with a 0.5 weight ratio of carbon to poly(vinyl butyral), after which the carbon particles are allowed to partially settle overnight. The resulting black solution is then filtered with a lab filter press unit. A 1 micron filter pad is used, which results in a clear and colorless varnish solution. The optical properties of the varnish are: L=97.96, [a*]=−0.56, [b*]=0.90, % Haze=1.23, [YI]=1.44 and % Tv=94.81.

### EXAMPLE 10

A comparative 10% varnish solution of virgin poly(vinyl butyral) resin is dissolved in ethanol at 70° C., cooled and tested for optical properties. The varnish solution has the following values L=99.52, [a*]=−0.20, [b*]=1.33, % Haze=1.97, [YI]=2.48 and % Tv=98.75.

### EXAMPLE 11

The poly(vinyl butyral) solution from Example 9 is subjected to the precipitation step: the pH of the solution is checked and adjusted to 6.8 to 7.2 range with either acetic acid or potassium acetate. The solution is poured into an Osterizer blender along with water added simultaneously at a 1:1 ratio of solution:water. When the blender is filled the contents are poured into a 5 liter agitated vessel that contains 1 liter of water. The precipitation is repeated until all of the poly(vinyl butyral) solution is processed. The precipitated poly(vinyl butyral) resin is then continuously washed at room temperature with de-ionized water and using a filter lance, which is a tube of about 13 millimeters diameter with an integrated filter and applied suction, to remove the effluent at a rate of 1 liter per minute for 15 minutes. The contents of the flask are then heated to 55° C. while continuing with agitating and washing for another 15 minutes at 1 liter per minute. At 55° C. the pH of the slurry is checked and adjusted to 6.8 to 7.2 and held at that pH for 45 minutes. The slurry is then washed with deionized water at a rate of 1 liter per minute for 15 minutes. The slurry is then adjusted with potassium acetate to obtain a final alkalinity titer of 30 to 40, after which it is cooled to room temperature. The cooled slurry is then filtered with a Buchner funnel, and the resin is dried in a fluid bed drier to a moisture content of less than 2.5%.

### EXAMPLE 12

The recycled resin from Example 11 is mixed with 38 phr triethylene glycol di-2-ethylhexanoate and processed into a polymer sheet of 0.762 millimeters (30 mil) thickness that is then laminated between two panes of glass to form a laminated glass panel. The panel is then visually inspected. Optical quality is noted to be high, and there are no obvious defects in the laminate.

### EXAMPLE 13

Poly(vinyl butyral) resin sample from Example 11 is analyzed with size exclusion chromatography (SEC) in HFIP solvent using a Spectra Physics AS3000 autosampler (Spectra Physics, Irvine, Calif.), a Spectra Physics P1000 pump (Spectra Physics, Irvine, Calif.), a Waters 410 differential refractometer (Waters Corporation, Milford, Mass.) and a Polymer Laboratories PL-GEL Mixed-C column (Polymer Laboratories Varian, Inc., Amherst, Mass.) in order to determine the molecular weight characteristics, Mn, Mw, and Mz values, and results are compared to SEC data of virgin poly(vinyl butyral) resin. Residual poly(vinyl alcohol) content and alkalinity titer values are determined via wet chemistry analysis. A solution is prepared by dissolving 3.195 grams of resin in 50 milliliters of methanol and viscosity is determined at 20° C. using a Cannon Fenske viscometer (Cannon Instrument Company, State College, Pa.). A 4″ diameter circular resin laminate is prepared by pressing 45 grams of resin in a mold and between circular glass panes at 150° C. and at 53,400 Newtons (12,000 lbs) of pressure for 30 minutes using a Pasadena Hydraulic Press (Pasadena Hydraulics, Inc., City of Industry, California) with 31.75 centimeters square (12.5″×12.5″) steam heated platents and driven by a 10.16 centimeter (4″) ram before cooling to room temperature. Yellowness index and haze values of the recycled resin laminate are then determined. Results are shown in Tables 1 and 2, below:

TABLE 1

| Sample ID | Mn | Mw | Mz | Mw/Mn |
|---|---|---|---|---|
| Virgin poly(vinyl | 7.4 × 10⁴ | 2.6 × 10⁵ | 6.1 × 10⁵ | 3.5 |
| butyral) Sample I | | | | |
| Virgin poly(vinyl | 1.0 × 10⁵ | 2.3 × 10⁵ | 4.2 × 10⁵ | 2.3 |
| butyral) Sample II | | | | |
| Recycled poly(vinyl | 9.2 × 10⁴ | 2.3 × 10⁵ | 4.8 × 10⁵ | 2.5 |
| butyral) | | | | |

TABLE 2

| | | Recycle PVB from | |
|---|---|---|---|
| | | Example #11 | |
| Poly(vinyl butyral) | Virgin Poly(vinyl | Sample | Sample |
| Property | butyral) Values | Test I | Test II |
| Poly(vinyl alcohol) % | 17.35-19.85 | 19.6 | 19.7 |
| Poly(vinyl acetate) % | 1.0-3.0 | 1.4 | 1.0 |
| Total Alkaline Titer | 5.0-55 | 40 | 44 |
| Viscosity | 0.115-0.215 | 135 | 127 |
| (Pascal · second)[centipoise] | [115-215] | | |
| at 20° C. | | | |
| Yellowness Index | 5-14 | not | 14.9 |
| | | tested | |
| Haze Value | 3-5 | not | 6.8 |
| | | tested | |

### EXAMPLE 14

Two poly(vinyl butyral) resins having the properties shown in table 3 are provided, where solubility is determined visually:

TABLE 3

| | Resin A | Resin B |
|---|---|---|
| Residual Poly(vinyl alcohol) % | 11.0 | 18.4 |
| (PVOH) | | |
| Mn | 137,000 | 89,000 |
| Mw | 495,000 | 247,500 |
| Mz | 1,310,000 | 513,000 |
| ETOH, 40° C. | soluble | soluble |
| ETOH, 25° C. | soluble | soluble |
| ETOH/water, 25° C. | insoluble | soluble |
| MeOH, 40° C. | partially | soluble |
| | soluble | |
| MeOH, 25° C. | insoluble | soluble |

### EXAMPLE 14

The resins from Example 13 are subjected to solubility testing. The resins are added to the solvents shown in table 4, and the solvent is heated to 60-65° C. with agitation for 1 hour and then cooled to 25° C. In trials in which poly(vinyl butyral) is determined initially to be insoluble in the solvent, a longer settling time is allotted before testing. A Mettler Toledo Halogen Moisture Analyzer model HR73, thermally stable glass-fiber filter pads, an aluminum sample pan, and a pipette are used.

The HR73 program is set to run for 20 minutes at 110° C. with weight-loss data printouts at 1.0 minute intervals.

The aluminum pan is tared with a glass-fiber filter pad, and, using a pipette, the sample solution is added to the filter pad to a weight of about 1 gram.

The HR73 start button is engaged and weight loss at 1.0 minute intervals is monitored until a constant weight-loss is attained. The average drying time is 10 minutes and samples are run in duplicates.

Calculation of % solids in solution (% TS) is [100−% weight loss]

Calculation of % dissolved poly(vinyl butyral) solids is

{[Total solvent added×% TS/100]/Total poly(vinyl butyral)added}×100

Results are provided in table 4, with weight in grams:

TABLE 4

| | | | | | | | TS % in | |
|---|---|---|---|---|---|---|---|---|
| | Resin | Resin | ETOH, | MEOH, | | Total soln, | Liquid | |
| | type | weight | weight | weight | Water, weight | weight | Phase | Solubility |
| 1 | A | 5.0 | 45.0 | — | — | 50.0 | 10.0 | Very |
| | | | | | | | | Soluble |
| 2 | A | 5.0 | 37.5 | — | 7.5 | 50.0 | 3.12 | Partially |
| | | | | | | | | Soluble |
| 3 | A | 5.0 | 35.0 | — | 10.0 | 50.0 | 0.33 | Mostly |
| | | | | | | | | Insoluble |
| 4 | A | 5.0 | 33.5 | | 11.5 | 50.0 | 0.03 | Insoluble |
| 5 | A | 5.0 | — | 45.0 | — | 50.0 | 0.01 | Totally |
| | | | | | | | | Insoluble |
| 6 | A | 5.0 | — | 40.0 | 5.0 | 50.0 | 0.00 | Totally |
| | | | | | | | | Insoluble |
| 7 | A | 5.0 | — | 37.5 | 7.5 | 50.0 | 0.00 | Totally |
| | | | | | | | | Insoluble |
| 8 | B | 5.0 | 45.0 | — | — | 50.0 | 10.0 | Very |
| | | | | | | | | Soluble |
| 9 | B | 5.0 | 35.0 | — | 10.0 | 50.0 | 10.0 | Very |
| | | | | | | | | Soluble |
| 10 | B | 5.0 | — | 45.0 | — | 50.0 | 10.0 | Very |
| | | | | | | | | Soluble |
| 11 | B | 5.0 | — | 40.0 | 5.0 | 50.0 | 1.00 | Mainly |
| | | | | | | | | Insoluble |

By virtue of the present invention, it is now possible to provide recycled poly(vinyl butyral) resin that can be used in place of, or in combination with, virgin poly(vinyl butyral) resin.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

It will further be understood that any of the ranges, values, or characteristics given for any single component of the present invention can be used interchangeably with any ranges, values, or characteristics given for any of the other components of the invention, where compatible, to form an embodiment having defined values for each of the components, as given herein throughout. For example, the various extraction step parameters and dissolution step parameters can be combined to form many permutations, where suitable, that are within the scope of the present invention, but that would be exceedingly cumbersome to list.

Any Figure reference numbers given within the abstract or any claims are for illustrative purposes only and should not be construed to limit the claimed invention to any one particular embodiment shown in any figure.

Figures are not drawn to scale unless otherwise indicated.

Each reference, including journal articles, patents, applications, and books, referred to herein is hereby incorporated by reference in its entirety.

We claim:

1. A method for recycling poly(vinyl butyral), comprising:
granulating laminated glass comprising said poly(vinyl butyral) and plasticizer to form granulated laminated glass;
disposing said granulated laminated glass in a first solvent that extracts said plasticizer;
removing said first solvent and said plasticizer from said granulated laminated glass;
adding a second solvent to said granulated laminated glass to dissolve said poly(vinyl butyral);
filtering said second solvent to remove impurities; and,
precipitating said poly(vinyl butyral) from said second solvent by adding water.

2. The method of claim 1, wherein said first solvent comprises acetone, hexane, methyl acetate, ethyl acetate, toluene, or heptane.

3. The method of claim 1, wherein said first solvent is a 75/25 volume/volume mixture of hexane and ethyl acetate.

4. The method of claim 1, wherein said disposing said granulated glass in a first solvent that extracts said plasticizer utilizes an immersion system in which granulated flappers are moved through a replenishing solvent bath.

5. The method of claim 1, wherein said second solvent comprises methanol, ethanol, propanol, isopropanol, n-butanol, methyl acetate, cyclohexanone, or diacetone alcohol.

6. The method of claim 1, wherein said second solvent comprises ethanol.

7. The method of claim 1, wherein said adding a second solvent to said granulated laminated glass to dissolve said poly(vinyl butyral) includes heating to just below the reflux temperature.

8. The method of claim 1, wherein said filtering includes mechanical filtering of said second solvent to an exclusion size of 0.1 to 10 microns.

9. The method of claim 1, wherein said filtering includes mechanical filtering of said second solvent to an exclusion size of 2 to 3 microns.

10. The method of claim 1, wherein said filtering includes activated carbon filtering of said second solvent.

11. The method of claim 10, wherein said activated carbon filtering includes adding activated carbon to said second solvent.

12. The method of claim 10, wherein said filtering includes mechanically filtering said activated carbon from said second solvent with an exclusion size of 1 micron.

13. The method of claim 1, wherein said precipitating includes high shear agitation in a blender, in-line mixer, or disintegrators as water is slowly added.

14. The method of claim 1, further including the steps of washing and drying said precipitated poly(vinyl butyral) resin after said precipitating.

15. A poly(vinyl butyral) resin mixture comprising poly(vinyl butyral) produced by the process comprising the steps of:
granulating laminated glass comprising said poly(vinyl butyral) and plasticizer to form granulated laminated glass;
disposing said granulated laminated glass in a first solvent that extracts said plasticizer;
removing said first solvent and said plasticizer from said granulated laminated glass;
adding a second solvent to said granulated laminated glass to dissolve said poly(vinyl butyral);
filtering said second solvent to remove impurities; and,
precipitating said poly(vinyl butyral) from said second solvent by adding water.

16. A laminated glazing comprising an interlayer comprising poly(vinyl butyral) produced by the process comprising the steps of:
granulating laminated glass comprising said poly(vinyl butyral) and plasticizer to form granulated laminated glass;
disposing said granulated laminated glass in a first solvent that extracts said plasticizer;
removing said first solvent and said plasticizer from said granulated laminated glass;
adding a second solvent to said granulated laminated glass to dissolve said poly(vinyl butyral);
filtering said second solvent to remove impurities; and,
precipitating said poly(vinyl butyral) from said second solvent by adding water.

17. The glazing of claim 16, wherein said interlayer has a haze value of less than 5 and a yellowness index of less than 14.

18. A method for recycling poly(vinyl butyral), comprising:
disposing granulated laminated glass in a first solvent that extracts said plasticizer;
removing said first solvent and said plasticizer from said granulated laminated glass;
adding a second solvent to said granulated laminated glass to dissolve said poly(vinyl butyral);
filtering said second solvent to remove impurities; and,
precipitating said poly(vinyl butyral) from said second solvent by adding water.

19. A method for recycling poly(vinyl butyral), comprising:
granulating laminated glass comprising a first poly(vinyl butyral) resin, a second poly(vinyl butyral) resin, and plasticizer to form granulated laminated glass;
disposing said granulated laminated glass in a first solvent that extracts said plasticizer;
removing said first solvent and said plasticizer from said granulated laminated glass;
adding a second solvent to said granulated laminated glass to dissolve said first poly(vinyl butyral) resin, wherein said second solvent does not dissolve said second poly(vinyl butyral) resin;
removing said second solvent and said first poly(vinyl butyral) resin from said granulated laminated glass;
filtering said second solvent to remove impurities; and,
precipitating said poly(vinyl butyral) from said second solvent by adding water.

20. The method of claim 19, further including the step of adding a third solvent to said granulated laminated glass to dissolve said second poly(vinyl butyral) resin.
